(19) United States
(12) Patent Application Publication
(10) Pub. No.: US 2004/0039921 A1
(43) Pub. Date: Feb. 26, 2004

(54) Method and system for detecting rogue software

(76) Inventor: Shyne-Song Chuang, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/399,540

(22) PCT Filed: Oct. 17, 2001
(86) PCT No.: PCT/SG01/00213

(30) Foreign Application Priority Data
Oct. 17, 2000 (SG) 200005973-3

(51) Int. Cl. G06F 11/30

(52) U.S. Cl. 713/187

(57) ABSTRACT

A method of detecting rogue software includes the step of creating a first database containing pre-calculated fingerprints for each file relating to typical operating systems and application software, wherein the pre-calculated fingerprints are calculated using one or more cryptographic formulae. The one or more cryptographic formulae are then used to calculate fingerprints of files on a computer system which is to be scanned for rogue software. The fingerprints calculated for the files on the computer system are compared with the fingerprints which are contained in the first database of pre-calculated fingerprints. Files on the computer system which may contain rogue software are identified by identifying files the calculated fingerprints of which do not correspond to the pre-calculated fingerprints which are stored in the first database.

### FI LD OF THE INVENTION

The present invention relates to a method and system for detecting rogue software such as trojan horses, root-kits, viruses and other unauthorized software which masquerades as valid software) on a computer system or data processing device such as a personal digital assistant. It relates particularly but not exclusively to a method and system for calculating and comparing fingerprints for files which are used either on a stand-atone computer system or on a computer system which is part of a computer network.

### BACK-GROUND TO THE INVENTION

Undesired rogue software is a nuisance and security threat. As computer systems and other information devices become even more interconnected with modem day networking technology and the Internet, the danger from rogue software has magnified considerably. Instead of being programmed to do damage once, today's rogue software can continue to receive commands and do the bidding of an unauthorized intruder for an extended period of time, effectively giving the creator of the rogue software continuous illegal access to a computer system.

One example of rogue software is the so-called trojan horse. Such software may be installed by innocent users unknowingly (whether via social engineering or otherwise) or it may be installed by an attacker when a system has been broken into. These trojan horses are back doors which allow an attacker to reconnect back into the compromised system and illegally access files and make unauthorized changes.

A trojan horse typically consists of new software and has new functionality. It is install d on a compromised system and disguised to look like original system software whenever necessary, so as to avoid detection. Sometimes, the trojan horse is a modified piece of original system software and is almost identical to the one it replaced. However, other techniques are also used to obfuscate its existence.

Once the trojan horse is installed, a user continues operating his/her system without knowing that an intruder is now able to access his/her data illegally whilst remaining hidden. These are highly relevant problems which are encountered on a day to day basis. Trojan horses such as “Back Orifice” or “Netbus” hit PC systems in the late 1990s, and “root-kits” are a concern for various UNIX systems.

Normally, according to current practice, little is done to prevent or detect such rogue software. Anti-virus vendors maintain databases of rogue software signatures, and their software searches for files on a system associated with all known rogue software. Unfortunately, this technique has inherent scaling problems—the more signatures there are, the slower the scan process for each file. More importantly, the only rogue software types that can be detected are the ones that the anti-virus vendors know about. If the rogue software is, as an example, a custom trojan horse built by an expert professional hacker for penetrating a specific target, none of the antivirus vendors will know about it. Therefore none of the anti-virus tools will be looking for it and the attacker and their trojan horse will exist completely undetected.

A more recent incremental innovation with this technology involves smarter scanning engines. Aside from looking for signatures of known rogue software, they are also able to look for software code that appears to be doing unusual things. This allows the scanning engine to detect additional rogue software that may not be known and whose signatures may not be in the database. However, this approach also has limitations. Trojan horses can be encrypted or compressed using special proprietary algorithms or encryption keying material. The rogue software is shipped in an encrypted and/or compressed format wh re it appears to be gibberish to a scanner. This rogue software is then decompressed or decrypted upon execution on the victim's computer system. A single trojan horse can thus be encrypted or compressed into thousands of possibilities, each with its own unique signature. Traditional scanning technology will fail miserably when attempting to detect this type of rogue software, since there is no way that anti-virus engin rs can keep track of thousands of mutations of the same piece of rogue software.

To summarise, today's scanning techniques for detecting rogue software fail for two main reasons:

1. They cannot detect unknown rogue software that has not already been identified. This is a serious problem because it is this kind of rogue software that may involve professional hackers and therefore warrant serious attention.

2. They cannot efficiently detect rogue software which has mutated, using new methods of compression and/or encryption. This problem exists to a large extent even for rogue software that is already known.

Another approach for detecting rogue software is to ensure that a system's files have not been altered, rather than looking for signatures of rogue software. If a system has no added files and all files remain unchanged from their original, unaltered state, it is clear that no rogue software is present on the system.

Academic work at Purdue University by Gene Kim and Gene Spafford resulted in a product called Tripwire which is now commercially sold. The product requires users to generate a database containing fingerprints of files on a system when the system is freshly loaded and in a pristine state. Subsequently, fingerprints can be recalculated and compared with the database of original pristine fingerprints and detect changes which have been made to the computer system.

This technology requires users to generate a database of fingerprints of a system's files while it is still pristine and free from alteration. This is not always feasible because many systems would already have been placed on public networks and exposed to risk for some time (often years). Since changes can be detected only by calculating new fingerprints and comparing them with the database of original fingerprints, any rogue software which already exists when the original fingerprint database was generated will not be detected.

Existing products do not use a central database of fingerprints which are acceptable for a broad collection of system and application software. Therefore users need to make the following tedious and expensive steps when installing a software upgrade:

1. Schedule downtime in which to create the new database of fingerprints;

2. Re-calculate fingerprints to ensure that no rogue software has been added;

3. Install the software upgrade; and

4. Generate a new fingerprint database.

This is often a time-consuming and costly exercise.

### SUMMARY OF THE INVENTION

Therefore it is an object of the present invention to provide a more reliable and effective method of identifying rogue software on a computer system or device, especially rogue software with unknown signatures or characteristics. The invention is preferably usable on systems or devices that have already been exposed to risk of intrusion by rogue software, and in cases where no fingerprints for the files on the system were calculated or archived when the system or device was known to be in a pristine state.

According to a first aspect of the invention, there is provided a method for detecting rogue software including the steps of:

(a) creating a first database containing pre-calculated fingerprints for each file relating to typical operating systems and application software, wherein the pre-calculated fingerprints are calculated using one or more cryptographic formulae;

(b) using the one or more cryptographic formulae to calculate fingerprints of files on a computer system which is to be scanned for rogue software;

(c) comparing the fingerprints calculated for the files on the computer system with the fingerprints which are contained in the first database of pre-calculated fingerprints; and

(d) identifying files on the computer system which may contain rogue software by identifying files the calculated fingerprints of which do not correspond to the pre-calculated fingerprints which are stored in the first database.

According to a second aspect of the invention, there is provided a system for detecting rogue software including:

(a) a first database containing pre-calculated fingerprints for each file relating to typical operating systems and application software, the fingerprints having been calculated using one or more cryptographic formulae;

(b) a software component which uses one or more cryptographic formulae to calculate fingerprints for files on a computer system; and

(c) a software component which compares the calculated fingerprints for the files on the computer system with corresponding pre-calculated fingerprints stored in the first database, such that files on the computer system which may contain rogue software are identified by identifying files the calculated fingerprints of which do not correspond to the pre-calculated fingerprints which are stored in the first database.

### BRIEF DESCRIPTION OF THE DRAWINGS

The invention will now be described in greater detail by reference to the drawings which show an example form of the invention. It is to be understood that the particularity of the drawings does not supersede the generality of the foregoing description of the invention.

FIG. 1 is a schematic representation of a client portion and server portion of a security system on a Redhat Linux platform connected via a network according to a preferred embodiment of the present invention.

FIG. 2 illustrates a more detailed data flow diagram relating to the schematic representation of FIG. 1.

### D TAILED DESCRIPTI N OF A PREF RRED EMBODIMENT OF THE INVENTION

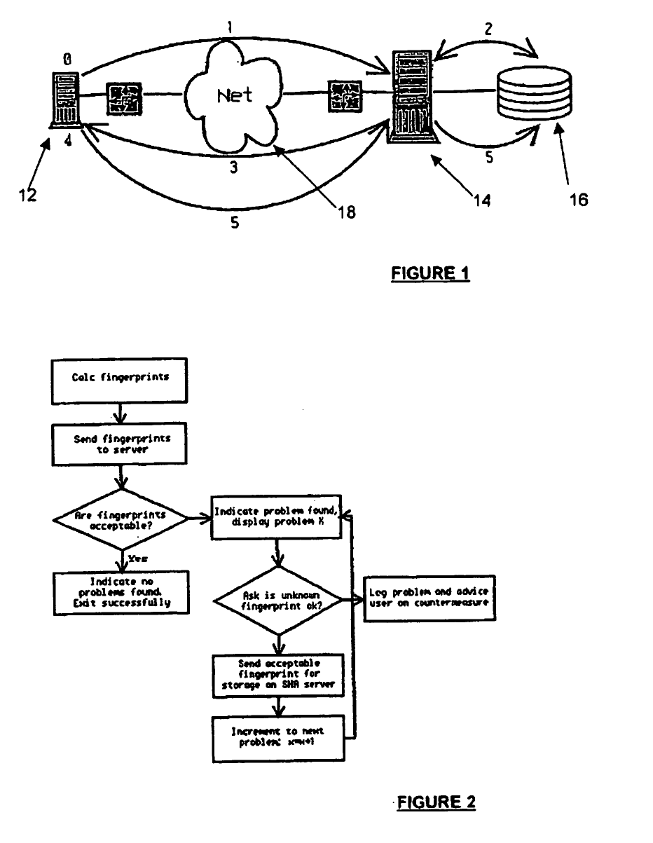

FIG. 1 is a schematic representation of a client portion and server portion of a security system on a Redhat Linux platform connected via a network 10 according to a preferred embodiment of the present invention. The system includes a client 12, a server 14 and a database of acceptable file fingerprints 16. Communication between the client 12 and server 14 may be via the Internet 18, using the TCP/IP protocol. The system is first set up by calculating and archiving fingerprints for all files relating to operating system or application software used in a typical Redhat Linux system, perhaps from original Redhat CDs or other secure software distribution methods. This software can be installed on test systems (not shown in FIG. 1) so that the new files added or replaced can be fingerprinted and profiled. These new fingerprints, the file location of each file added or replaced, and other information, can then be stored in the database of acceptable file fingerprints 16. An alternative method that eradicates the need for software installation on a test system involves the use of a custom developed program that understands the RPM (Redhat Package Manager) format of software packages on the Redhat Linux CD. By examining each RPM software package's installation instructions, the program determines the file location and calculates the fingerprints of each file to be installed. This information and other information is then stored in the database of acceptable file fingerprints 16.

The fingerprints are preferably calculated using one or more cryptographic formulae. In the preferred embodiment, such cryptographic formulae may include hash functions to generate hash values for each file, or asymmetric cryptographic functions to generate digital signatures for each file. The original version of the files as well as patches, updates/upgrades of all types of operating system or application software should be fingerprinted. System performance and reliability will improve as more op rating system and application software is fingerprinted and archived.

Hashing is a contraction of the file contents created by a cryptographic hash function. A hash value (or simply hash) is the output when an arbitrary input is passed into a hash function. The hash is substantially smaller than the input itself, and is generated by a formula in such a way that it is extremely unlikely that slight modifications of the input will result in the same hash. Hashes conventionally play a role in security systems where they are used to ensure that transmitted messages have not been tampered with. As an illustration, a sender generates a hash of the message and sends it with the message itself. The recipient then calculates another hash from the received message, and compares the two hashes. If they are the same, there is a very high probability that the message was transmitted intact. There may be other equivalent methods for calculating fingerprints that may be implemented as the relevant technology develops.

The system's client component is installed on the client 12 that requires file integrity protection. During the first time the client component is executed, the client software recurses through the file system and calculates and stores the cryptographic hash of every single file on the system. When the file system has been completely traversed, the client software makes a secure TCP/IP connection via the Internet 18 to the sever component on the server, which usually resides on premises remote from the client component. However, the client component need not be physically located remote from the server component.

For security purposes, it is preferable that bi-directional authentication takes place between the client component and the server component before any further communication and this can be done with SSL (Secure Socket Layer) or TLS (Transport Layer Security). In a nutshell, the server presents its digital certificate to the client software and the client uses its hardwired CA (Certificate Authority) public credentials to verify the CA signature on the server's certificate. If the signature is authentic and the server's address matches the machine which the certificate was issued to, the client can be certain that the server is who it claims to be. Subsequently, the same thing happens in the reverse direction. The client presents the server with its digital certificate and the server goes through the same process to verify that the client is who h claims to be. This practice is very common today and is an industry standard method of mutually authenticating two nodes communicating with one another. Other authentication methods may also be used.

The calculated hash results and gathered basic client system information from the client 12 are then transferred to the server 14 for validation. On the server 14, each hash result for each file on the client system is compared against what are the expected hash values given certain parameters such as the client system's operating system version and software patch/update level. This expected hash information is fetched from the database of acceptable file fingerprints 16 which houses all the pre-calculated hash values for all files in various operating systems and applications.

A report is then generated on the fly and returned to the client 12. This report lists the files on the client which are possibly unsafe since they do not represent authentic software from the vendor. There are 3 possible results for each file:

(a) the hash result matches so the given file on the client is definitely authentic;

(b) the database of acceptable fingerprints 16 has no information on such a file in the database and it is uncertain if the file is authentic;

(c) the hash result does not match the fingerprint in the database of acceptable fingerprints 16 and the file is suspicious.

Armed with this report, the systems administrator for the client server 12 can then verify each of the files in categories (b) and (c). Outcomes in categories (b) and (c) are typically from files that are part of an internal customer specific application that the database 16 will not contain. If the administrator verifies the hash with the owners of the application, the authenticity of the file can be determined. This should be done for all questionable files in the report so that a client system can be certified as 100% authentic. If some of th questionable files cannot b resolved via these means, it is likely that they have been augmented by rogue software and should be replaced or the system should be reinstalled.

Using additional management software, the administrator can then check off all remaining questionable files as acceptable and the security system will take the additional hashes into account in all subsequent runs. These additional hashes can then be stored in a second database (not shown in FIG. 1) so that they can be considered when checking other systems from the same customer—this is a configurable feature.

FIG. 2 illustrates a more detailed data flow diagram relating to the schematic representation of FIG. 1. Using the database of pre-calculated acceptable fingerprints 16, the system will be able to determine if any given file on a client's system is authentic, i.e. not invaded by rogue software. When comparisons are, done, file location, time stamps platform information, user preferences and other parameters can also be taken into consideration.

The system should be continuously updated with new fingerprint information in the database of acceptable file fingerprints 16 as new software and updates become available. The system thus provides pristine fingerprint information that is made available to the file integrity checking software installed on a client's computer system. Instead of identifying bad files, the system therefore ensures that the data is good. Instead of requiring users to have generated a fingerprint database some time back, the system provides pre-calculated fingerprints and greatly reduces the barriers to adoption of this important file integrity technology.

In addition to the above, the system may also store fingerprints of various customers' files in a separate database (not shown in FIG. 1) so that the system can provide heuristic, statistically based best effort guesses on whether a certain fingerprint is acceptable for a given file.

In the above exampl, in the event of a questionable outcome (categories (b) and (c)) where the system does not have pre-calculated hash information on a certain file on the cli nt, the system may also render a heuristic result on whether a file is safe. This result can be provided by accessing the second database (not shown in FIG. 1) which contains hashes that the customer's administrators have confirmed to be acceptable. For example, if the system does not know about whether a file such as “/usr/bin/myspecialprogram” should have a hash result of “xyz”, it can inform the administrator, and also point out one of the following:

1) no other systems in the client's class have such a file so authenticity is uncertain;

2) other systems in the client's class which have such a file do not have a hash of “xyz” so the file is suspicious;

3) other systems in the client's class which have such a file have the same hash of “xyz” so the file is probably safe.

This information can also be provided with a percentage figure so that administrators have a best guess of where they stand before engaging in manual verification as described above.

As the client base grows, this information will allow the system to make increasingly improved guesses. The system can render an opinion along the lines of “10,000 other customers have this file and 9,985 of them have the same fingerprint, so your file is probably safe”—perhaps a common application whose fingerprint that does not already exist in the first database 16. Such information, while not substantive, allows users to zoom into more critical anomalies on their systems sooner. For example, consider this other response: “10,000 other customers have this file and no one has the same fingerprint as you. Worse yet, all these 10,000 customers have the same fingerprint so your file is most probably unsafe.” The system can thus provide a percentage or quantifiable risk rating in either a numeric fashion or with the use of colours.

From the client's point of view, the advantage is that even systems currently deployed in risky public network environments can be easily reliably scanned and put onto a file integrity protection regime without re-installation to assure a pristine stat and with significantly reduced downtime. As customers apply upgrades to their systems, the system will similarly be able to verify that new software being installed is authentic since the fingerprints of the n w software should be in the system's database 16. Conversely, the system can be programmed to warn the user if the update contains software the system does not believ is authentic.

While a particular embodiment of the invention has beet shown and described, it will be obvious to those skilled in the art that changes and modifications of the present invention may be made without departing from the invention in its broader aspects. As such, the scope of the invention should not be limited by the particular embodiment and specific construction described herein but should be defined by the appended claims and equivalents thereof. Accordingly, the aim in the appended claims is to cover all such changes and modifications as fall within the spirit and scope of the invention.

1. A method of detecting rogu software including the steps of:
(a) creating a first database containing pre-calculated fingerprints for each file relating to typical operating systems and application software, wherein the pre-calculated fingerprints are calculated using one or more cryptographic formulae;
(b) using the one or more cryptographic formulae to calculate fingerprints of files on a computer system which is to be scanned for rogue software;
(c) comparing the fingerprints calculated for the files on the computer system with the fingerprints which are contained in the first database of pre-calculated fingerprints;
(d) identifying files on the computer system which may contain rogue software by identifying files the calculated fingerprints of which do not correspond to the pre-calculated fingerprints which are stored in the first database.

2. A method according to claim 1 including the further step of generating a list of questionable files on the computer system for which the calculated fingerprints do not correspond to pre-calculated fingerprints stored in the first database.

3. A method according to claim 1, wherein the cryptographic formulae used in the pre-calculation of fingerprints which are stored in the first database and in the calculation of fingerprints for files on the computer system, use one or more hash functions to generate hash values for each file.

4. A method according to claim 1, wherein cryptographic formulae used in the pre-calculation of fingerprints which are stored in the first database and in the calculation of fingerprints for files on the computer system, use one or more asymmetric cryptographic functions to generate digital signatures for each file.

5. A method according to claim 2 wherein questionable files are considered by a system administrator and may be marked by the system administrator as acceptable.

6. A method according to claim 5 wherein the fingerprints for questionable files which are accepted by the system administrator are stored in a second database.

7. A method according to claim 6 which includes the step of calculating the probability that a questionable file has been corrupted by rogue software, by comparing its fingerprint with fingerprints for similar files that have previously been accepted by the system administrator and stored in the second database.

8. A method according to claim 7 wherein the system provides statistical information regarding.
(a) the number of fingerprints in the second database which represent files with the same characteristics as the questionable file;
(b) the number of fingerprints in the second database which are identical to the fingerprint of the questionable file;
(c) the number of fingerprints in the second database which are different to the fingerprint of the questionable file.

9. A method according to claim 5 wherein files that are not acceptable are replaced or reinstalled.

10. A method according to claim 6 wherein the step of calculating fingerprints for files on the computer system and the step of comparing fingerprints on the computer system with corresponding pre-calculated fingerprints stored on the first database are both implemented by the computer system and wherein verification of questionable files takes place before fingerprints from the computer system are added to the second database.

11. A method according to claim 10 wherein the computer system is physically remote from the first database and communication between the computer system and the first database takes place over a network such as the Internet.

12. A method according to any one of claims 6 to 8 wherein the step of calculating fingerprints for the files on the computer system is implemented by the computer system and the step of comparing the fingerprints which represent files on the client system with corresponding pre-calculated fingerprints stored in the database is implemented by a server, and wherein verification of questionable files takes place between the computer system and the server before the corresponding fingerprints are transferred from the computer system to the second database.

13. A method according to claim 12 wherein the computer system is physically remote from the server and communication between them takes place over a communications network such as the Internet.

14. A system for detecting rogue software including:
(a) a first database containing pre-calculated fingerprints for each file relating to typical operating systems and application software, the fingerprints having been calculated using one or more cryptographic formulae;
(b) a software component which uses one or more cryptographic formulae to calculate fingerprints for files on a computer system; and
(c) a software component which compares the calculated fingerprints for the files on the computer system with corresponding pre-calculated fingerprints stored in the first database, such that files on the computer system which may contain rogue software are identified by identifying files the calculated fingerprints of which do not correspond to the pre-calculated fingerprints which are stored in the first database.

15. A system according to claim 14 including a software component which generates a list of questionable files for which the calculated fingerprints do not correspond to the pre-calculated fingerprints which are stored in the first database.

16. A system according to claim 14 or 15 wherein the software components are installed on the computer system.

17. A system according to claim 14 wherein the pre-calculation of fingerprints which are stored in the first database and calculation of fingerprints for files on the computer system use one or more hash functions to generate hash values for each file.

18. A system according to claim 14 wherein the pre-calculation of fingerprints which are stored in the database and calculation of fingerprints for files on the computer system use one or more asymmetric cryptographic functions to generate digital signatures for each file.

19. A system according to claim 15 further including a second database in which fingerprints of questionable files which are found to be acceptable by a system administrator are stored.

20. A system according to claim 15 wherein the system calculates the probability that a questionable file is a file that has been corrupted by rogue software, by comparing its fingerprint with fingerprints for similar files that have been verified and stored in the second database.

21. A system according to claim 20 wherein the system produces statistical information regarding:
(a) the number of fingerprints in the second database which represent files with the same characteristics as the questionable file;
(b) the number of fingerprints in the second database which are identical to the fingerprint of the questionable file;
(c) the number of fingerprints in the second database which are different to the fingerprint of the questionable file.

22. A system according to claim 19 wherein files that are not acceptable are replaced or reinstalled.

23. A system according to any one of claims 14 to 22 wherein the step of calculating fingerprints of files on the computer system and the step of comparing the fingerprints on the computer system with corresponding pre-calculated fingerprints stored on the database are both implemented by the computer system and wherein verification of questionable files takes place before fingerprints from the computer system are added to the second database.

24. A system according to claim 23 wherein the computer system is physically remote from the first database and communication between the computer system and the first database takes place over a network such as the Internet.

25. A system according to any one of claims 14 to 20 wherein the step of calculating fingerprints for the files on the computer system is implemented by the computer system and the step of comparing the fingerprints which represent files on the computer system with corresponding pre-calculated fingerprints stored in the first database is implemented by a server and wherein verification of questionable files takes place between the computer system and the server before the corresponding fingerprints are transferred between them.

26. A system according to claim 25 wherein the computer system is physically remote from the server and communication between them takes place over a communication network suck as the Internet.
